(19) United States
(12) Patent Application Publication
(10) Pub. No.: US 2007/0086090 A1
(43) Pub. Date: Apr. 19, 2007

(54) Image display device and optical element for forming stereoscopic image used in the same

(75) Inventors: Wen-Chun Wang, Tai Chung City (TW); Han-Chang Lin, Tai Chung City (TW); Fa-Chen Wu, Sze Hu Hsiang (TW); Yi-Chin Wang, Wu Chi Town (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/248,192

(22) Filed: Oct. 13, 2005

(51) Int. Cl. G02B 27/22

(52) U.S. Cl. 359/464; 359/462

(57) ABSTRACT

An image display device includes a display panel and a parallax optic. The display panel is provided with a stripe sub-pixel arrangement in which sub-pixels arranged in a first direction have identical colors, and sub-pixels arranged in a second direction have distinct colors. The pixel density in the first direction is twice the pixel density in the second direction of the stripe sub-pixel arrangement. The parallax optic has view-separation elements arranged in the first direction into multiple rows. Each view-separation element is positioned corresponding to two adjacent sub-pixels, and the view-separation elements in one row are staggered relative to the view-separation elements in immediately adjacent rows.

### BACKGROUND OF THE INVENTION

(a) Field of the Invention

The invention relates to an image display device, and particularly to an image display device capable of being switched between 2D and 3D display modes.

(b) Description of the Related Art

FIG. 1 shows a schematic diagram illustrating a conventional image display device 100 in which a parallax optic is installed to create stereoscopic images. Referring to FIG. 1, the image display device 100 includes a liquid crystal panel 102 and a parallax barrier plate 104. The parallax barrier plate 104 consisting of a glass substrate 118 and multiple spaced opaque stripes 120 formed thereon is in contact with one side of the liquid crystal panel 102. The barrier plate 104 is used as a view-separation optic to block one eye from seeing any images prepared for the other eye.

In the liquid crystal panel 102, a liquid crystal layer 110 is sandwiched between a pair of glass substrates 106 and 108. Further, a polarizer 112 is provided on the glass substrate 106 at its side neighboring an observer (light-emitting side), and a polarizer 114 is provided on the substrate 108 at its side neighboring a backlight 116 (light-incoming side). Referring again to FIG. 1, parallax stereogram images are made by interleaving the pixel columns from left and right eye perspective images of a 3D scene. After light emits from the backlight 116, the light outgoing from the left-eye pixel columns and that from the right-eye pixel columns are respectively observed by the left eye and the right eye by means of the parallax barrier plate 104. In other words, the parallax stereogram images and the parallax barriers are aligned so that the left eye can only see the left-eye pixel columns and the right eye can only see the right-eye pixel columns due to different viewing angles. Thereby, an observer is allowed to perceive stereoscopic images.

However, in that case, display of one 3D pixel needs at least two adjacent 2D pixels horizontally arranged respectively for both eyes, and thus the horizontal resolution in a 3D display mode is reduced to half the horizontal resolution in a 2D display mode.

Hence, in order to improve the effective horizontal resolution of a 3D display, a pixel arrangement called horizontally double-density pixels (HDDP) structure is proposed by NEC Corporation. Referring to FIG. 2A, a horizontal RGB stripe arrangement in order to obtain a higher resolution is chosen in the HDDP structure, where RGB sub-pixels arranged in the horizontal direction (X-direction) have identical colors, and RGB sub-pixels arranged in the vertical direction (Y-direction) have distinct colors. Besides, the screen area is partitioned into multiple pixel blocks 128, and each pixel block 128 is equally divided into a rectangular pixel 128A (including R1, G1, and B1 sub-pixels) and a rectangular pixel 128B (including R2, G2, and B2 sub-pixels) for respectively representing left-eye and right-eye image data, so that the horizontal pixel density is twice the vertical pixel density in the HDDP structure.

Further, the hatch lines shown in FIG. 2A illustrates the alignment of the parallax barriers 126A and 126B in relation to the pixel arrangement in the HDDP structure. As shown in FIG. 2A, each parallax barrier, such as the parallax barrier 126A, is arranged in the vertical direction (Y-direction) corresponding to two adjacent pixel columns, the left eye pixel column M1 and the right eye pixel column M2. Hence, through a proper alignment of the parallax barriers 126A and 126B in relation to the pixel arrangement, the left eye of an observer may observe the pixel columns M1 and N1 while the right eye may observe the pixel columns M2 and N2, as shown in FIG. 2B. As a result, the effective horizontal resolution in a 3D display mode is equal to that in a 2D display mode due to the doubled horizontal pixel density.

However, there is still much room for improving the resolution and image quality when the HDDP structure is applied. For instance, it is well known that sub-pixel rendering (SPR) technique is often used to enhance the display resolution and image quality. However, the sub-pixel rendering technique must work together with a pixel layout where both red and green sub-pixels are available in each vertical column and horizontal row to provide full color capability. For example, a Pentile Matrix layout 130 with alternating checkerboard of red and green sub-pixels is used in the sub-pixel rendering technique, as shown in FIG. 3. On the contrary, referring back to FIG. 2B, the pixel arrangement seen by each eye of an observer in the conventional HDDP structure is a strip pixel arrangement, with all three RGB sub-pixels emerging in the vertical direction but all sub-pixels in each horizontal row having identical colors. As a result, even if the sub-pixel rendering technique performs in conjunction with the strip pixel arrangement, either addressability or modulation transfer function (MTF) in the horizontal axis will never increase to improve image quality.

### BRIEF SUMMARY OF THE INVENTION

An object of the invention is to provide an image display device that has an improved image quality and is capable of being switched between 2D and 3D display modes.

Another object of the invention is to provide an optical element for forming stereoscopic images that allows the implementation of sub-pixel rendering (SPR) in conjunction with a horizontally double-density pixels (HDDP) structure to improve image quality.

According to the invention, an image display device includes a display panel and a parallax optic. The display panel is provided with a stripe sub-pixel arrangement in which sub-pixels arranged in a first direction have identical colors, and sub-pixels arranged in a second direction have distinct colors. The pixel density in the first direction is twice the pixel density in the second direction of the stripe sub-pixel arrangement. The parallax optic is placed at one side of the display panel and has view-separation elements arranged in the first direction into multiple rows. Each view-separation element is positioned corresponding to two sub-pixels respectively representing right-eye image data and left-eye image data, and the view-separation elements in one row are staggered relative to the view-separation elements in immediately adjacent rows, so that a delta sub-pixel arrangement is seen by each eye of an observer.

Through the design of the invention, since the view-separation elements in one row are staggered relative to the view-separation elements in immediately adjacent rows, each eye of an observer can see either of two complementary delta RGB sub-pixel arrangements. Under the circumstance, both red and green sub-pixels are available in each vertical column and horizontal row in a delta RGB sub-pixel arrangement to provide full color capability, and the sub-pixel rendering technique thus can be performed in conjunction with the delta RGB sub-pixel arrangement to improve image quality.

Further, an optical element for forming stereoscopic images is used in the image display device. The optical element includes a base and a plurality of view-separation elements formed thereon. The view-separation elements are arranged into multiple rows corresponding to a stripe sub-pixel arrangement of a display screen where sub-pixels arranged in the same row have identical colors. The view-separation elements in one row are staggered relative to the view-separation elements in immediately adjacent rows, so that a delta RGB sub-pixel arrangement is seen by each eye of an observer.

### BRIEF DESCRIPTION OF THE DRAWINGS

FIG. 1 shows a schematic diagram illustrating a conventional image display device in which a parallax optic is installed to create stereoscopic images.

FIG. 2A shows a horizontal stripe pixel arrangement of a conventional HDDP structure, and FIG. 2B shows two complementary stripe RGB sub-pixel arrangements respectively seen by the right and left eyes of an observer through view separation.

FIG. 3 shows a schematic diagram illustrating a conventional Pentile Matrix pixel layout.

FIGS. 4A and 4B show schematic diagrams illustrating an embodiment of the invention.

FIG. 5A shows a schematic diagram illustrating the positions of view-separation elements in relation to a horizontal stripe pixel arrangement of a conventional HDDP structure.

FIG. 5B shows two complementary delta RGB sub-pixel arrangements respectively seen by the right and left eyes of an observer according to the invention.

FIGS. 6A and 6B show schematic diagrams illustrating the calculation principle of sub-pixel rendering in conjunction with the invention.

FIG. 7 shows the compare result of resolution between the invention and a conventional HDDP structure design.

FIGS. 8A and 8B show schematic diagrams illustrating another embodiment of the invention.

FIG. 9 shows a schematic diagram illustrating another embodiment of the invention.

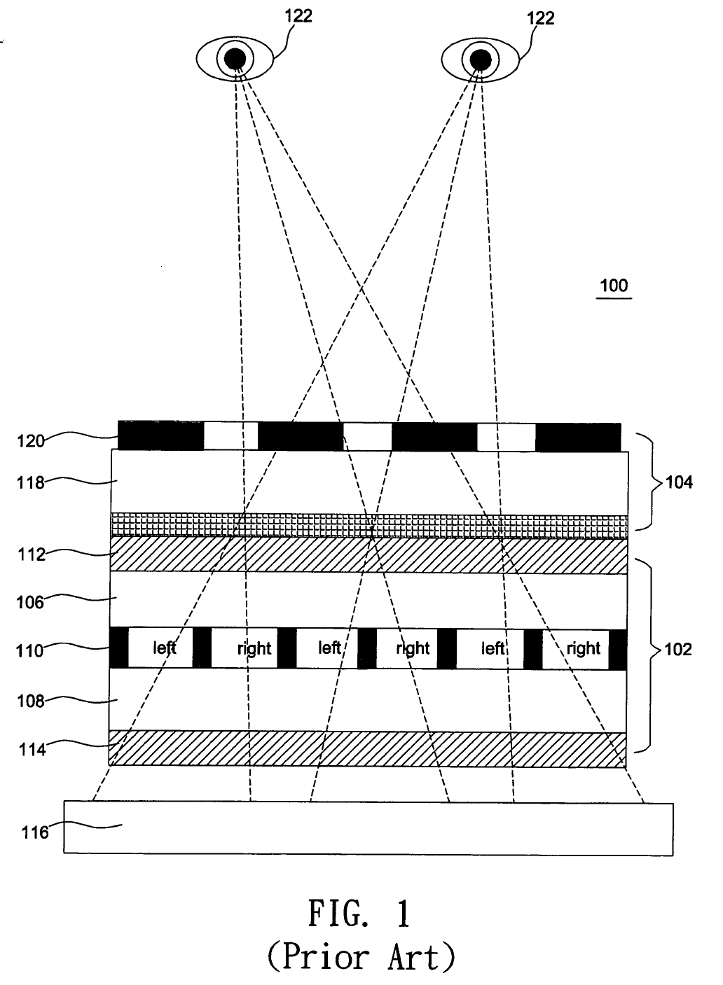

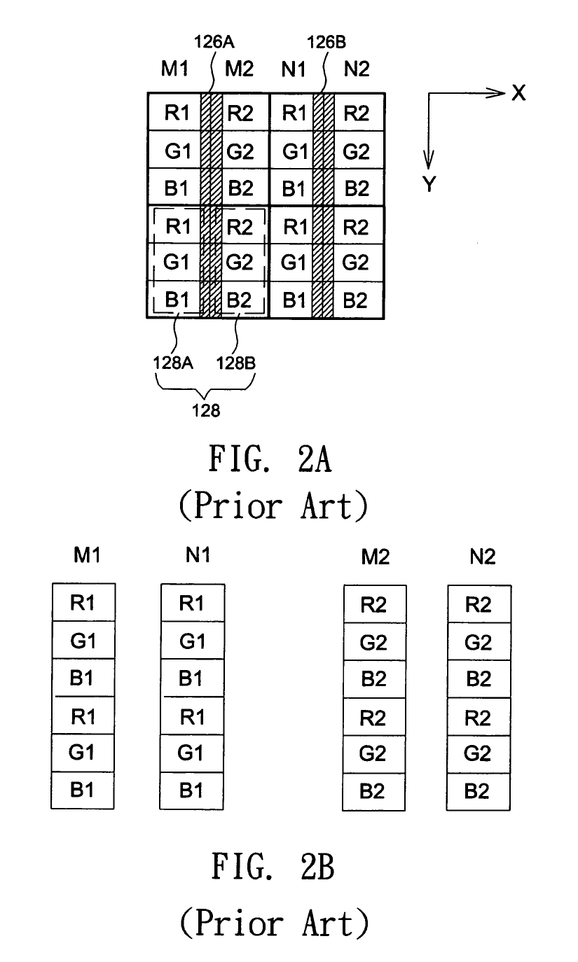

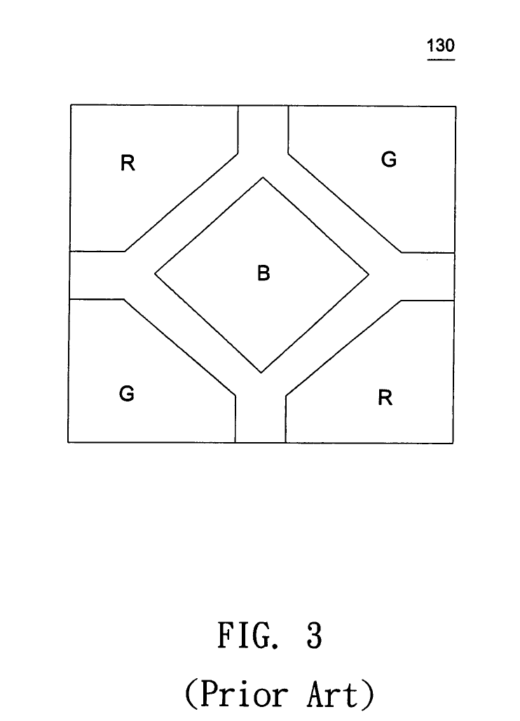

### DETAILED DESCRIPTION OF THE INVENTION

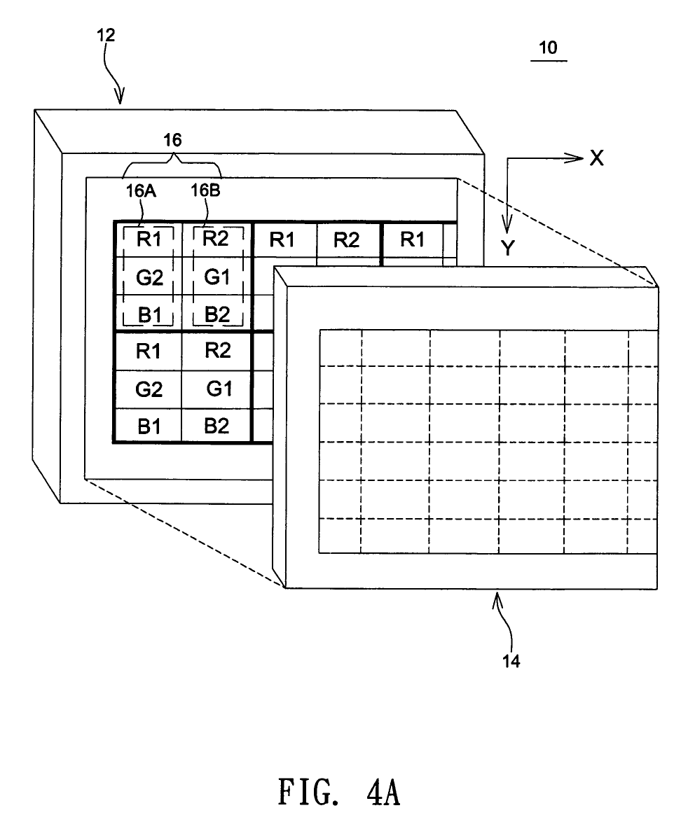

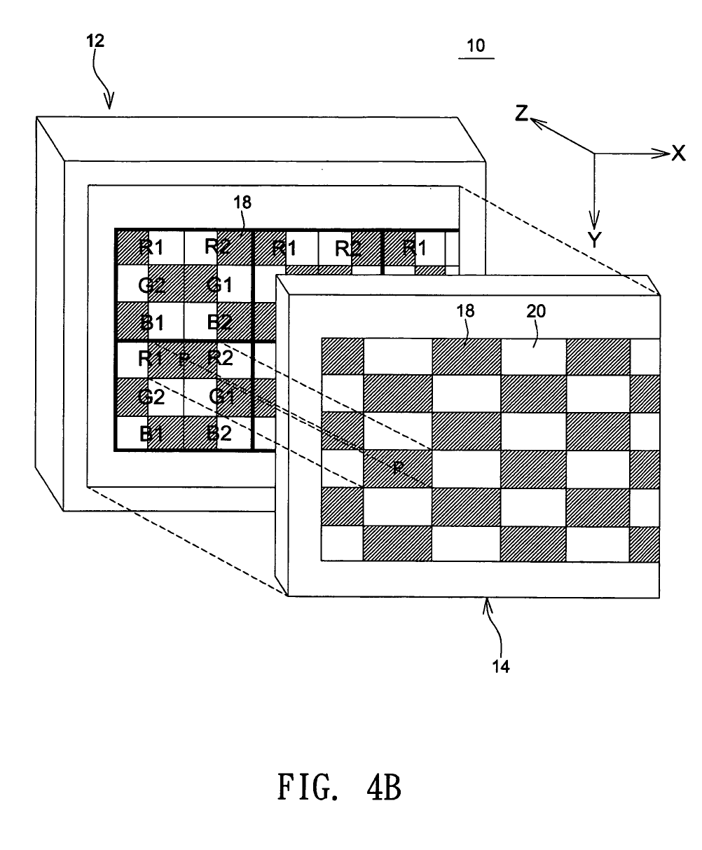

FIGS. 4A and 4B show schematic diagrams illustrating an embodiment of the invention. In this embodiment, an image display device 10 includes a display panel 12 and a liquid crystal shutter 14 placed at one side of the display panel 12. The display panel 12 may be a LCD panel having a pixel arrangement similar to the horizontally double-density pixel (HDDP) structure. Specifically, referring to FIG. 4A, a horizontal RGB stripe arrangement is chosen where RGB sub-pixels arranged in the horizontal direction (X-direction) have identical colors, and RGB sub-pixels arranged in the vertical direction (Y-direction) have distinct colors. Besides, the screen area is partitioned into multiple pixel blocks 16, and each pixel block 16 is divided into a rectangular pixel 16A (including R1, G2, and B1 sub-pixels) and a rectangular pixel 16B (including R2, G1, and B2 sub-pixels) for respectively representing left-eye and right-eye image data. In this embodiment, the respective pixels for the left and right eyes are designed to be rectangular, and the two rectangular pixels together form a pixel block 16, preferably in a square shape. Hence, the horizontal pixel density is twice the vertical pixel density. Note that each rectangular pixel contains at least one red, green and blue sub-pixels, with the sub-pixel being actually the smallest addressable unit.

In this embodiment, the liquid crystal shutter 14 is used as the parallax optic to block one eye from seeing any images prepared for the other eye. When the liquid crystal shutter 14 is turned off, as shown in FIG. 4A, light may pass through all areas of the liquid crystal shutter 14 to result in a 2D display mode. On the contrary, when the liquid crystal shutter 14 is turned on, as shown in FIG. 4B, applied voltages may alter the orientation of liquid crystal molecules in the shutter 14 to partition the shutter area into multiple spaced opaque sections 18 and transparent sections 20.

As shown in FIG. 4B, referring to the alignment of the opaque sections 18 and the transparent sections 20 in relation to the pixel layout on the screen area, it is clearly seen that each opaque section 18 (such as section P) or each transparent section 20 is positioned corresponding to two adjacent sub-pixels (such as R1 and R2) that respectively represent left-eye image data and right-eye image data. Specifically, as indicated by the hatch lines, the projection of the opaque section P in the Z-axis direction on the display screen may partially overlap two adjacent sub-pixels having identical colors and respectively representing the left-eye image data and the right-eye image data. Besides, each transparent section and each opaque section are alternately arranged in the horizontal and the vertical direction to form a checkerboard pattern. In other words, the opaque sections 18 in one row are staggered relative to the opaque sections 18 in immediately adjacent rows, and also the transparent sections 20 in one row are staggered relative to the transparent sections 20 in immediately adjacent rows. The view-separation elements, namely the opaque sections 18 and the transparent sections 20, may keep the left and right eye images directed solely at the appropriate eye to result in a 3D display mode.

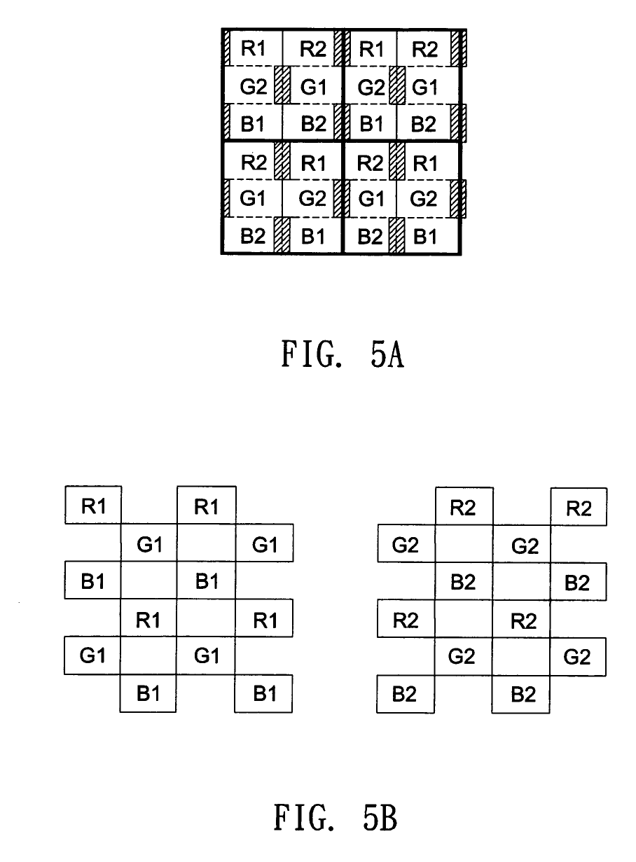

According to the invention, since the view-separation elements in one row are staggered relative to the view-separation elements in immediately adjacent rows, each eye of an observer can see either of the two complementary delta RGB sub-pixel arrangements, as shown in FIG. 5B. Under the circumstance, both red and green sub-pixels are available in each vertical column and horizontal row in a delta RGB sub-pixel arrangement to provide full color capability, and the sub-pixel rendering technique thus can be performed in conjunction with the delta RGB sub-pixel arrangement to improve image quality.

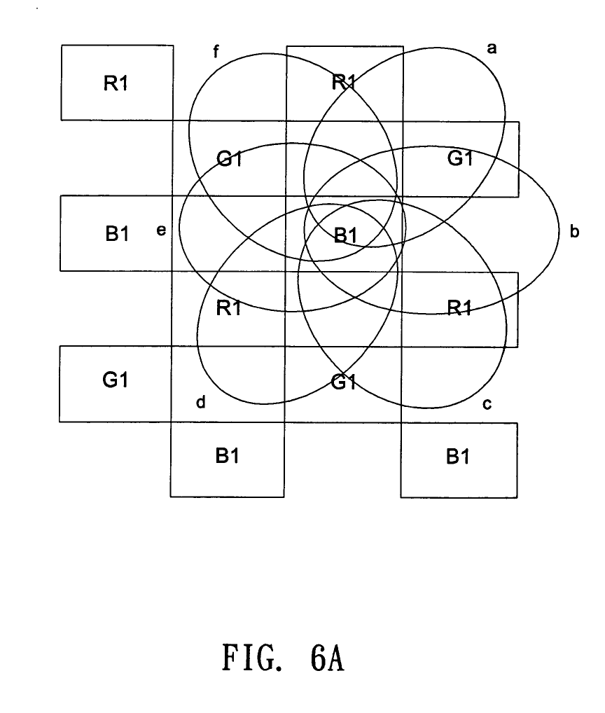

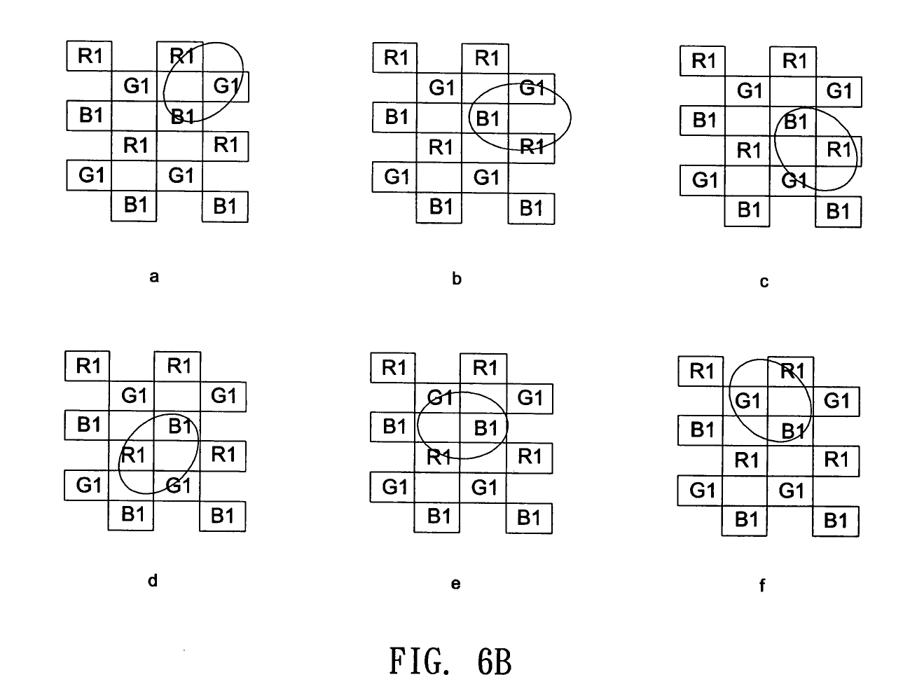

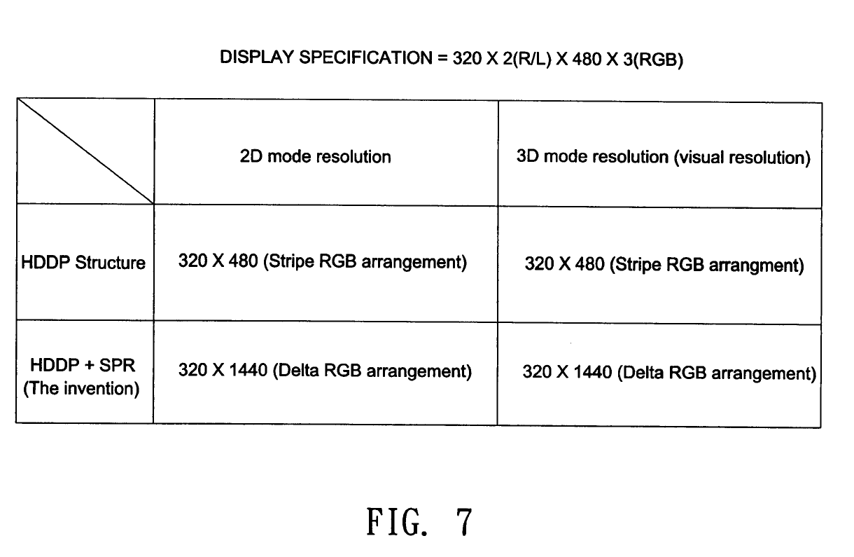

Referring to FIGS. 6A and 6B, as the sub-pixel rendering technique is applied, the adjacent physical RGB sub-pixels are taken out to perform calculations so as to create a large amount of logic sub-pixels. As a result, the visual resolution is improved and sawtooth patterns are also effectively eliminated to result in a fine display of images. Through the design of the invention, since the sub-pixel rendering technique can be performed in conjunction with the delta RGB sub-pixel arrangement, its 2D resolution and 3D resolution are both threefold compared to the conventional design of a HDDP structure. The compare result is listed in FIG. 7.

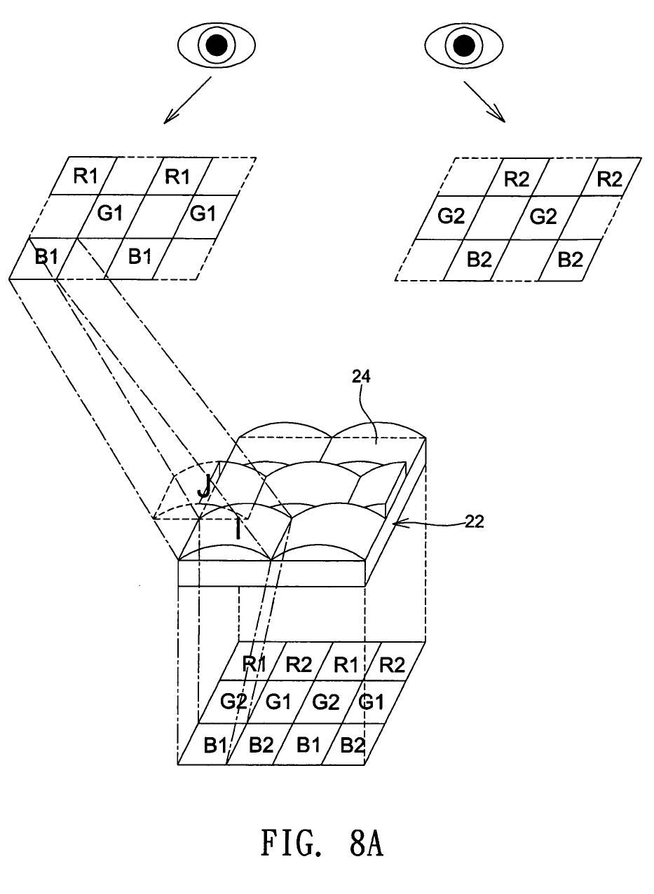

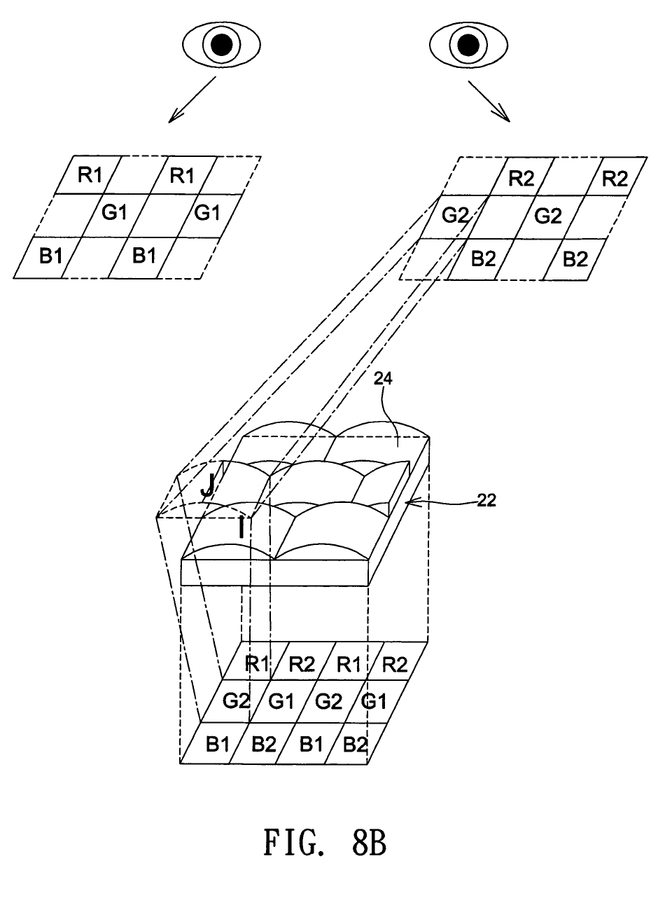

FIGS. 8A and 8B show schematic diagrams illustrating another embodiment of the invention, where a lenticular sheet 22 is used as the parallax optic to create stereoscopic images. The lenticular sheet 22 contains a series of cylindrical lenses 24 molded into a plastic substrate, and all cylindrical lenses 24 are arranged into multiple rows, with each cylindrical lens 24 being arranged corresponding to two horizontally adjacent sub-pixels (such as sub-pixels B1 and B2) having identical colors and respectively representing left-eye image data and right-eye image data.

According to the design of this embodiment, the cylindrical lenses 24 in one row are staggered relative to the cylindrical lenses 24 in immediately adjacent rows. For example, the cylindrical lens I arranged corresponding to sub-pixels B1 and B2 is horizontally staggered relative to the cylindrical lens J arranged corresponding to sub-pixels G1 and G2. Through such design, the right eye may see the sub-pixel B1 by the refraction of the cylindrical lens I, as shown in FIG. 8A, while the left eye may see the sub-pixel G2 by the refraction of the cylindrical lens J as shown in FIG. 8B, with the sub-pixels B1 and G2 being arranged in the same column. As a result, each eye of an observer may see either of the two complementary delta RGB sub-pixel arrangements.

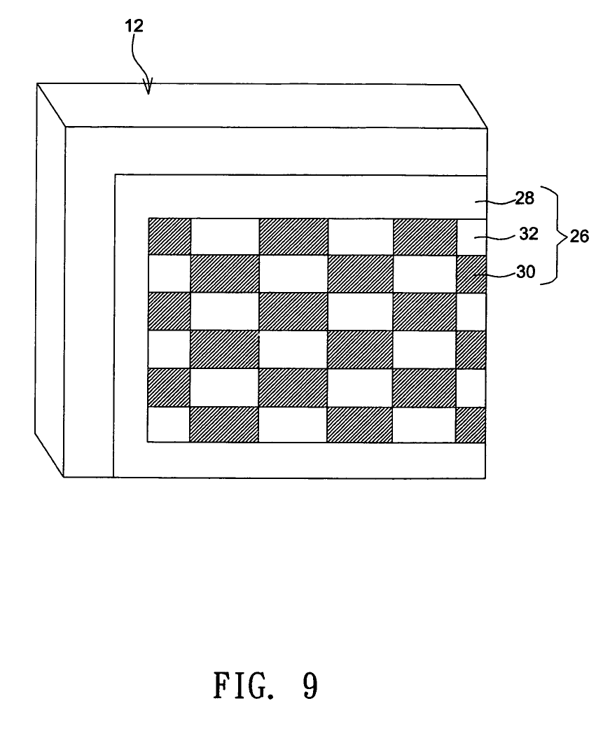

FIG. 9 shows a schematic diagram illustrating another embodiment of the invention, where a parallax barrier plate 26 is used as the parallax optic to create stereoscopic images.

In the parallax barrier plate 26, opaque materials may be printed onto a transparency film 28 to form multiple alternately arranged opaque sections 30 and transparent sections 32 functioning as the view-separation elements. Also, in this embodiment, the opaque sections 30 in one row are staggered relative to the opaque sections 30 in immediately adjacent rows, and so are the transparent sections 32.

Hence, it can be seen that the view-separation elements used in the subject invention includes, but is not limited to, opaque sections and transparent sections of a liquid crystal shutter or a parallax barrier plate, and cylindrical lenses of a lenticular sheet. Other optical elements may also be used as they are capable of having each eye of an observer see a delta RGB sub-pixel arrangement.

Besides, since each pixel block is divided into two rectangular pixels for respectively representing right-eye image data and left-eye image data, the image display device of the invention is capable of being switched between 2D and 3D display modes according to the type of image data. Specifically, the image display device runs in a 2D display mode as the right-eye image data and the left-eye image data are the same, while the image display device runs in a 3D display mode as the right-eye image data and the left-eye image data are different.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An image display device, comprising:
a display panel provided with a stripe sub-pixel arrangement in which sub-pixels arranged in a first direction have identical colors, and sub-pixels arranged in a second direction have distinct colors, the pixel density in the first direction being twice the pixel density in the second direction of the stripe sub-pixel arrangement; and
a parallax optic placed at one side of the display panel and having view-separation elements arranged in the first direction into multiple rows, each view-separation element being positioned corresponding to two sub-pixels respectively representing right-eye image data and left-eye image data, and the view-separation elements in one row being staggered relative to the view-separation elements in immediately adjacent rows, so that a delta sub-pixel arrangement is seen by each eye of an observer.

2. The image display device as claimed in claim 1, wherein the first direction is the horizontal direction and the second direction is the vertical direction, and the sub-pixels comprising red (R), green (G), and blue (B) sub-pixels.

3. The image display device as claimed in claim 1, wherein the parallax optic is a liquid crystal shutter, and the image display device runs in a 2D display mode as the liquid crystal shutter is turned off, while the image display device runs in a 3D display mode as the liquid crystal shutter is turned on.

4. The image display device as claimed in claim 3, wherein the liquid crystal shutter is partitioned into a plurality of transparent sections and opaque sections when it is turned on, and each transparent section and each opaque section are alternately arranged in the first and the second directions to form a checkerboard pattern.

5. The image display device as claimed in claim 4, wherein the view-separation elements are the alternately arranged transparent sections and opaque sections.

6. The image display device as claimed in claim 4, wherein the transparent sections and opaque sections are in a rectangular shape.

7. The image display device as claimed in claim 1, wherein the parallax optic is a lenticular sheet, and the lenticular sheet has a plurality of cylindrical lenses functioning as the view-separation elements.

8. The image display device as claimed in claim 1, wherein the parallax optic is a parallax barrier plate, and the parallax barrier plate has a plurality of alternately arranged transparent sections and opaque sections functioning as the view-separation element.

9. The image display device as claimed in claim 1, wherein the delta sub-pixel arrangement is used as a pixel layout for implementing sub-pixel rendering (SPR) technique.

10. An image display device, comprising:
a display panel whose screen area is partitioned into multiple pixel blocks, each pixel block being divided into two rectangular pixels for respectively representing right-eye image data and left-eye image data, and each rectangular pixel comprising at least one red (R), green (G), and blue (B) sub-pixels; and
a parallax optic placed at one side of the display panel and having view-separation elements arranged into multiple rows, each view-separation element being positioned corresponding to two adjacent sub-pixels that belong to distinct rectangular pixels, and the view-separation elements in one row being staggered relative to the view-separation elements in immediately adjacent rows, so that a delta RGB sub-pixel arrangement is seen by each eye of an observer.

11. The image display device as claimed in claim 10, wherein the sub-pixels arranged in the horizontal direction of the screen area have identical colors, and the sub-pixels arranged in the vertical direction of the screen area have distinct colors.

12. The image display device as claimed in claim 10, wherein the image display device runs in a 2D display mode as the right-eye image data and the left-eye image data are the same, while the image display device runs in a 3D display mode as the right-eye image data and the left-eye image data are different.

13. The image display device as claimed in claim 10, wherein the delta RGB sub-pixel arrangement is used as a pixel layout for implementing sub-pixel rendering (SPR) technique.

14. The image display device as claimed in claim 10, wherein the parallax optic is a liquid crystal shutter, and the image display device runs in a 2D display mode as the liquid crystal shutter is turned off, while the image display device runs in a 3D display mode as the liquid crystal shutter is turned on.

15. The image display device as claimed in claim 14, wherein the liquid crystal shutter is partitioned into a plurality of transparent sections and opaque sections when it is turned on, and each transparent section and each opaque section are alternately arranged to form a checkerboard pattern.

16. The image display device as claimed in claim 15, wherein the view-separation elements are the alternately arranged transparent sections and opaque sections.

17. The image display device as claimed in claim 10, wherein the parallax optic is a lenticular sheet, and the lenticular sheet has a plurality of cylindrical lenses functioning as the view-separation elements.

18. The image display device as claimed in claim 10, wherein the parallax optic is a parallax barrier plate, and the parallax barrier plate has a plurality of alternately arranged transparent sections and opaque sections functioning as the view-separation elements.

19. An optical element used for forming stereoscopic images, comprising:
a base; and
a plurality of view-separation elements formed on the base and arranged thereon into multiple rows corresponding to a stripe sub-pixel arrangement of a display screen where sub-pixels arranged in the same row have identical colors, and the view-separation elements in one row being staggered relative to the view-separation elements in immediately adjacent rows, so that a delta RGB sub-pixel arrangement is seen by each eye of an observer.

20. The optical element as claimed in claim 19, wherein each of the view-separation element is positioned corresponding to two adjacent sub-pixels respectively representing right-eye image data and left-eye image data.
